(19) United States
(12) Patent Application Publication
(10) Pub. No.: US 2025/0289040 A1
(43) Pub. Date: Sep. 18, 2025

(54) LASER DESCALING SYSTEM WITH MAGNETIC ROBOTIC CONTROLS

(71) Applicant: SAUDI ARABIAN OIL COMPANY, Dhahran (SA)

(72) Inventors: Sameeh Issa BATARSEH, Dhahran (SA); Rami JABARI, Houston, TX (US)

(73) Assignee: SAUDI ARABIAN OIL COMPANY, Dhahran (SA)

(21) Appl. No.: 18/605,508

(22) Filed: Mar. 14, 2024

(51) Int. Cl. B08B 7/00; B08B 5/02; B08B 5/04; B08B 9/043

(52) U.S. Cl. CPC B08B 7/0042; B08B 5/02; B08B 5/04; B08B 9/043; B08B 2209/04

(57) ABSTRACT

A laser descaling tool includes a laser head formed of a magnetic or ferromagnetic material, a flexible laser arm defining first and second ends, the flexible laser arm coupled to the laser head at the first end and responsive to modification of a magnetic field to reorient the laser head, a support arm coupled to the flexible laser arm at the second end, a fiber optic cable extending through the flexible laser arm and the support arm to a control location, a laser source disposed at the control location and optically coupled to the laser head through the fiber optic cable, and a vacuum mounted at the second end of the laser arm and operable to collect debris from a scale deposit within an interior of a pipe.

### FIELD OF THE DISCLOSURE

The present disclosure relates generally to laser descaling tools for use in pipes and, more particularly, to systems and methods for aiming a laser beam at the scale deposits on interior surfaces of the pipes.

### BACKGROUND OF THE DISCLOSURE

Oil and gas operations extensively utilize piping circuits formed of pipes and flow control components for fluid transport, e.g., for transporting fluids into and out of wells. Scale buildup within these pipes is a common issue, particularly when water producing wells are involved. As water travels through the pipes, minerals dissolved in the water may be deposited as scale against the inner surfaces of the pipes and flow control components. Various scale types may be deposited including calcite, halite, barite, anhydrite, gypsum, and iron sulfide depending on the volume, salinity, temperature, and pressure of the water. Scale buildup may reduce the effective diameter of the pipes and may lead to restricted flowrates therethrough. Initial layers of scale deposition may corrosively damage the pipe and may lead to an acceleration of further scale buildup as well.

Both chemical and mechanical techniques have been developed for prevention or removal of scale deposits within pipes. Chemical scale removal techniques may utilize acids to cat away at the accumulated scale deposits, while mechanical scale removal may employ abrasive elements for dislodging scale from the interior surfaces of the pipes. However, the acids and abrasives may not act solely on the scale deposits, but may adversely affect the materials of which the pipes are constructed. For example, the acids and abrasives may generate pores within the metals, ceramics, elastomers and other materials forming the interior surfaces of the pipes, and may therefore damage or weaken of the pipes leading to contamination, leakage, and downtime to allow for repairs or replacements.

Accordingly, a non-damaging scale removal tool is desirable for removing scale deposits in pipes without negatively affecting pipe integrity.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a pipe descaling system includes a pipe having a scale deposit on an inner circumferential surface thereof, one or more crawlers selectively movable on an outer circumferential surface of the pipe, one or more magnetic field generators carried by the one or more crawlers and operable to produce a magnetic field, and a laser descaling tool operable to emit a laser beam. The laser descaling tool includes a support arm extending into the interior of the pipe, a flexible laser arm having a first end coupled to an end of the support arm within the interior of the pipe, and a laser head coupled to a second end of the flexible arm and defining an opening through which the laser beam is emitted, the laser head formed of a magnetic or ferromagnetic material such that the laser head is attracted or repelled by the magnetic field and such that movement of the magnetic field generators with the crawlers on the outer circumferential surface of the pipe flexes the flexible arm to reorient the laser head.

In another embodiment, a method for descaling a pipe includes advancing a laser descaling tool into the pipe towards a scale deposit, the laser descaling tool including a laser head formed of magnetic or ferromagnetic materials, positioning a magnetic field generator on an outer circumferential surface of the pipe, generating, via the magnetic field generator, a magnetic field at or near a location of the laser descaling tool, activating a laser source optically coupled to the laser head to thereby emit a laser beam from the laser head at a first target location on the scale deposit, removing scale from the first target location with the laser beam, and modifying the magnetic field by tuning or repositioning the magnetic field generator on the outer circumferential surface of the pipe to thereby attract or repel the laser head with the magnetic field and reorient the laser head such that the laser beam is emitted at a second target location on the scale deposit.

In a further embodiment, a laser descaling tool includes a laser head formed of a magnetic or ferromagnetic material, a flexible laser arm defining first and second ends, the flexible laser arm coupled to the laser head at the first end and responsive to modification of a magnetic field to reorient the laser head, a support arm coupled to the flexible laser arm at the second end, a fiber optic cable extending through the flexible laser arm and the support arm to a control location, a laser source disposed at the control location and optically coupled to the laser head through the fiber optic cable, and a vacuum mounted at the second end of the laser arm and operable to collect debris from a scale deposit within an interior of a pipe.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1A is a schematic side view of a laser descaling tool for use within a pipe, according to at least one embodiment of the present disclosure.

FIG. 1B is a schematic side view of the laser head of the laser descaling tool, according to an embodiment of the present disclosure.

FIG. 2 is a schematic side view of a robotic crawler deployable on an outer circumferential surface of the pipe, according to at least one embodiment of the present disclosure.

FIG. 3 is a schematic side view of a system including a laser descaling tool disposed in an interior of a pipe and a plurality of robotic crawlers deployed on an outer circumferential surface of the pipe, according to at least one embodiment of the present disclosure.

FIG. 4 is a flowchart for an example method for descaling one or more pipes via a laser descaling tool and robotic crawlers, according to at least one embodiment of the present disclosure.

FIG. 5 is a block diagram of a computer system that may be used to implement one or more of the systems or methods described herein in accordance with certain embodiments of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to descaling tools for use in pipes and, more particularly, to laser descaling tools controllable via tunable magnetic fields and robotics deployed on an outer circumferential surface of the pipe. The systems, apparatus, and methods described herein may utilize a laser head mounted on a flexible arm to enable free movement of the laser head within the pipe. The laser head may be constructed with magnetic or ferromagnetic materials such that the laser head may be selectively attracted or repelled by the magnetic fields. The magnetic fields may be provided via robotic crawlers carrying magnetic field generators, or other devices capable of generating a magnetic field, mounted on outer circumferential surfaces of the pipe. Tuning of the magnetic field and translation of the robotic crawlers, may position and orient the laser head within the pipe. Thus, through fine control of the magnetic field, the laser head may be aimed with precision.

The embodiments disclosed herein may employ a control unit for operation of the laser descaling tool and the magnetic field generators. The control unit may communicate with any sensors or cameras on the laser descaling tool, and may receive location and power information from the magnetic field generators or robotic crawlers. The control unit may autonomously instruct or otherwise control the laser descaling tool in response to the received signals. In further embodiments, the control unit may enable an operator to adjust and fine tune operational parameters of the laser descaling tool and magnetic field generators. In some embodiments, the laser descaling tool, one or more robotic crawlers, and the control unit are used in a system further including a laser source to descale a pipe using a high-powered laser beam. The use of a high-powered laser beam within the pipe may limit degradation of the pipe during descaling, particularly when compared to chemical and mechanical descaling operations. Further, the high-powered laser beam may be utilized in the removal of a variety of scale deposit compositions, such that the methods and systems described herein may be used for scale removal in any pipe and conditions.

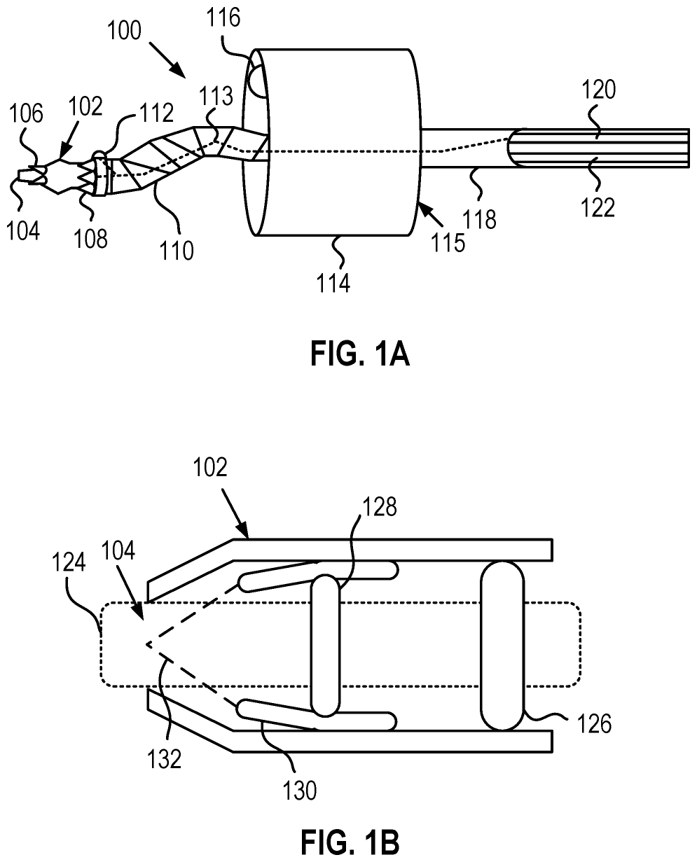

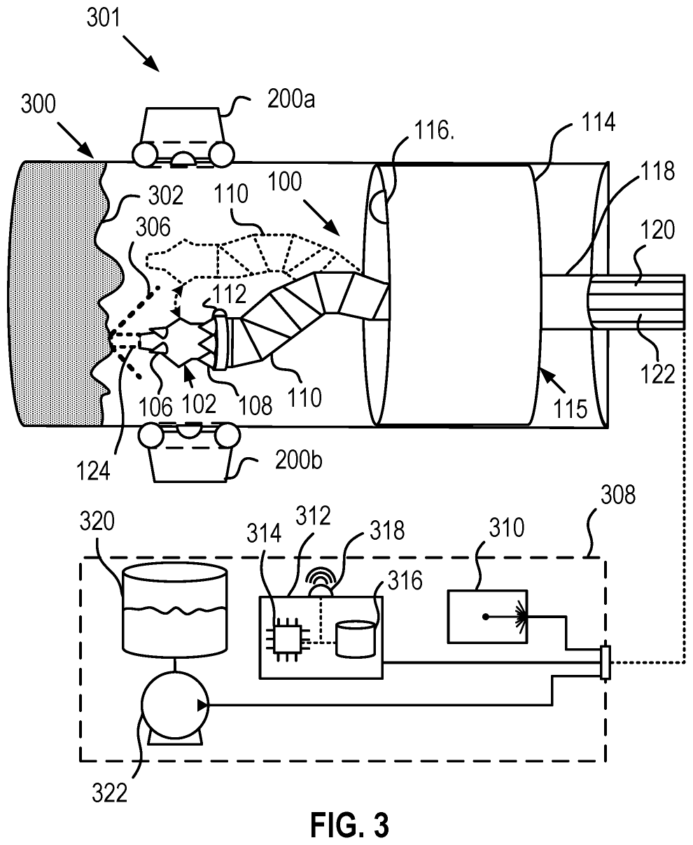

FIG. 1A is a schematic side view of an example laser descaling tool 100 for use within a pipe (see pipe 300 of FIG. 3), according to at least one embodiment of the present disclosure. The laser descaling tool 100 (hereinafter, “the tool 100”) includes a laser head 102 for emitting a high-powered laser beam 124 (FIG. 1B), and thereby removing scale within the pipe. The laser head 102 may be made of iron, iron alloys, or any other ferromagnetic materials compatible with the temperatures and pressures of the descaling application. In operation, the position and orientation of the laser head 102 may be controlled via a magnetic field to aim the laser head 102 at scale deposits or another desired location. The laser head 102 may include or define an opening 104 through which the laser beam 124 may exit the laser head 102 towards a scale deposit. In some embodiments, the laser head 102 may include a focusing lens (not shown) within the opening 104 for controlling or intensifying the high-powered laser. In these embodiments, the focusing lens in the opening 104 may further separate the interior of the laser head 102 from the ambient surroundings and prevent damage to any internal components.

The laser head 102 may further include a plurality of distal or first purging nozzles 106 mounted at or near the opening 104. The first purging nozzles 106 may expel a purging fluid for removing and preventing obstructions in front of the opening 104, and to ensure the high-powered laser may reach the intended target scale deposit. The laser head 102 may further include a plurality of proximal or second purging nozzles 108 at or near a base of the laser head 102. The second purging nozzles 108 may further protect the laser head 102 from debris and may prevent undesirable movement of the laser head 102 due to debris collision. In some embodiments, the first and second purging nozzles 106, 108 may expel purging fluids such as nitrogen gas or compressed air for clearing the laser path and removing debris.

The laser head 102 may be coupled, or otherwise attached, to a flexible laser arm 110. The flexible laser arm 110 may permit transfer of laser energy therethrough to the laser head 102. In some embodiments, the flexible laser arm 110 may enable fluid communication between the first purging nozzles 106, second purging nozzles 108, and a fluid source. The flexible laser arm 110 may be formed of a plurality of segments that pivot with respect to one another and to enable free manipulation and translation of the laser head 102 during operation. Accordingly, as the laser head 102 is attracted or repelled by a magnetic field, the flexible laser arm 110 may flex to accommodate the movement of the laser head 102 without restricting the passage of laser energy and purging fluids therethrough.

In some embodiments, one or more sensors 112 may be provided on the laser head 102, the flexible laser arm 110, or a combination thereof. The sensors 112 may enable monitoring of a status the tool 100 and the ambient environment during operation, and may include thermocouples, pressure transducers, acoustic transducers, and flowmeters. In some embodiments, acoustic transducers of the sensors 112 may generate images and measure a distance between the laser head 102 and a target. The flexible laser arm 110 may further include one or more fiber optic cables 113 in communication with the laser head 102 and the sensors 112. The fiber optic cables 113 may transmit the laser energy and any signals through the flexible laser arm 110 during operation.

In some embodiments, the flexible laser arm 110 includes a vacuum 114 mounted thereon and operable to draw debris from the ambient environment at or near the laser head 102. As illustrated, the vacuum 114 may include a cylindrically-shaped body sized to closely fit within the pipe of interest. Thus, the vacuum 114 may isolate a working area forward of the vacuum 114 (around the flexible laser arm 110 and laser head 102) from an area behind the vacuum 114. The vacuum 114 may pull debris from the working area and expel the debris from a back end 115 away from the working area and laser head 102. In some embodiments, the vacuum 114 may be connected to a disposal or storage unit (not shown) for collection and eventual disposal of the removed debris. In some embodiments, the vacuum 114 may support a camera 116 thereon for monitoring of the interior of the pipe during operation. In other embodiments, the camera 116 may be mounted at or near the laser head 102 or the flexible laser arm 110.

The tool 100 may further include a support arm 118 through which the tool 100 may be coupled to a control location 308 (FIG. 3). In some embodiments, the support arm 118 may be constructed as a generally rigid tube that supports the flexible laser arm 110 and which may be advanced through the interior of the pipe to advance the tool 100 in operation. In some embodiments, the support arm 118 may be a coiled tubing included within or mated to the tool 100 for advancing the tool 100. In further embodiments, however, the support arm 118 may be a robotic arm autonomously or remotely controlled to advance the tool 100.

The support arm 118 may include a fiber optic bundle 120 as well as a fluid transport bundle 122. The fiber optic bundle 120 may include or optically connect to one or more fiber optic cables, such as the fiber optic cables 113, coupled to the laser head 102, sensors 112 and/or camera 116. The fiber optic bundle 120 may thus transmit optical power therethrough for providing laser energy to the fiber optic cable 113 and laser head 102, and may also transmit data and instruction signals. For example, signals indicative of parameters detected by the sensors 112 and/or images captured by the camera 116 may be transmitted to the control location 308, and instructions or command signals may be transmitted from the control location 308 to the camera 116 via the fiber optic bundle 120. The fluid transport bundle 122 may provide purging fluids to the first purging nozzles 106 and the second purging nozzles 108 from a fluid source (see, e.g., purging fluid source 320 illustrated in FIG. 3), as discussed above. In some embodiments, the vacuum 114 may be mounted at the coupling between the flexible laser arm 110 and the support arm 118. Both the fiber optic bundle 120 and the fluid transport bundle 122 may accordingly extend into or through the vacuum 114 and/or into the flexible laser arm 110 to enable the functionality discussed above.

FIG. 1B is an enlarged schematic side view of the laser head 102 of the laser descaling tool 100, according to one or more embodiments of the present disclosure. In the illustrated embodiment, a high-powered laser beam 124 may be emitted from the laser head 102 during operation. The high-powered laser beam 124 may pass through a first focusing lens 126 as it travels through the laser head 102. The focusing lens 126 may control a shape, size, or intensity of the high-powered laser beam 124 to prepare for descaling operations. The high-powered laser beam 124 may further pass through a cover lens 128 which may form a translucent fluid barrier within the laser head 102. In some embodiments, the focusing lens 126 and cover lens 128 may be a single lens or extended prism within the laser head 102.

The laser head 102 may further include one or more internal purging nozzles 130 surrounding the cover lens 128. The internal purging nozzles 130 may emit a purging fluid, similar to the first purging nozzles 106, to generate a fluid knife 132 in a path of the high-powered laser beam 124. The fluid knife 132 may further protect the laser head 102 from debris, external fluids, and blockages in the path of the high-powered laser beam 124 via a constant output of the purging fluid. In some embodiments, the first purging nozzles 106 may be included within the laser head 102, such that the internal purging nozzles 130 are the first purging nozzles 106 discussed above.

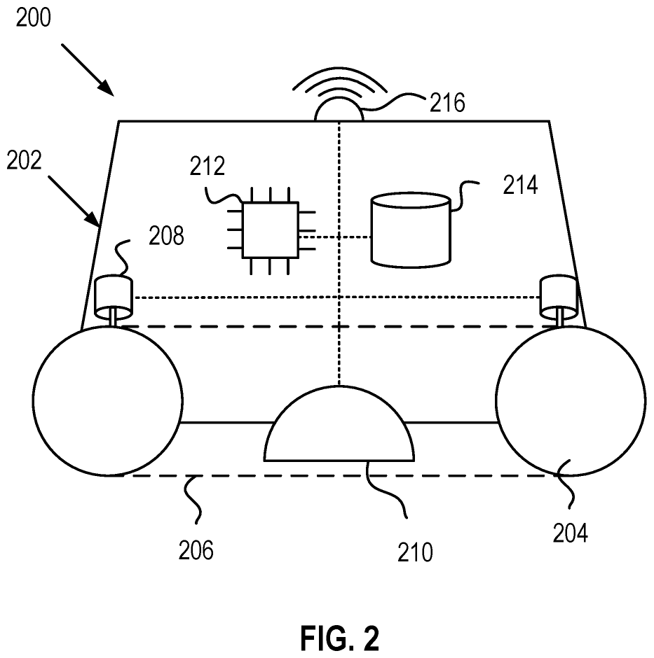

FIG. 2 is a schematic side view of an example robotic crawler 200 deployable on an outer circumferential surface of a pipe, according to at least one embodiment of the present disclosure. As described above, the laser head 102 of FIGS. 1A-1B may be controllable with a magnetic field and, in some embodiments, one or more robotic crawlers 200 are provided for generation of the magnetic field. The robotic crawler 200 may include a body 202 for housing a plurality of internal components and supporting a plurality of external components. The robotic crawler 200 may further include a plurality of wheels 204 coupled to the body 202 for translation (movement) and rotation of the robotic crawler 200 on and around a pipe. In some embodiments, the wheels 204 may include one or more permanent magnets, such that the robotic crawler 200 may be magnetically attracted to a pipe constructed of steel or similar metal and remain attached to the pipe at any orientation. In further embodiments, the wheels 204 are connected to one another via a plurality of tracks 206 (e.g., endless tracks), which may similarly include permanent magnets to attach the robotic crawler 200 to the pipe. The wheels 204 may be operably coupled to one or more motors 208 housed within the body 202 to power rotation of the wheels 204.

The robotic crawler 200 may include a magnetic field generator 210 mounted within or onto the body 202. The magnetic field generator 210 may include electromagnets operable to selectively or tunably generate a magnetic field directed perpendicularly away from the body 202 of the robotic crawler 200. Accordingly, as the robotic crawler 200 travels around a pipe, the magnetic field generator 210 may enable fine control of the position and orientation of the laser head 102 of FIGS. 1A-B within the interior of the pipe.

The magnetic field generator 210 and the motors 208 may be controlled via a processor 212 and computer-readable medium 214 disposed within the body 202. As illustrated, the processor 212 and computer-readable medium 214 may be in communication with the motors 208 and the magnetic field generator 210, as well as a wireless communicator 216. The wireless communicator 216 may enable connectivity between a control location and the processor 212 of the robotic crawler 200. The control location may receive images or information from the tool 100 of FIG. 1A and may instruct the processor 212 to adjust the motors 208 or magnetic field generator 210 accordingly. The wireless communicator 216 may further enable communication and coordination with additional robotic crawlers 200, such that synchronized control of any generated magnetic fields may be performed. The wireless communicator 216 may utilize Wi-Fi, Bluetooth, radio frequency (RF), or any other wireless communication technology.

FIG. 3 is a schematic side view of an example system 301 including the laser descaling tool 100 deployed within the interior of a pipe 300 and a plurality of robotic crawlers 200a-b deployed on an outer circumferential surface of the pipe 300, according to at least one embodiment of the present disclosure. The tool 100 is illustrated at a location within the pipe 300 where the tool 100 has advanced to a site of deposited scale 302. The deposited scale 302 may be a deposit formed of calcite, halite, barite, anhydrite, gypsum, iron sulfide, or any combination thereof. In example operation, the laser head 102 outputs the high-powered laser beam 124 aimed at a first target location on the deposited scale 302 by the crawlers 200a-b. As the high-powered laser beam 124 penetrates, melts, ablates, erodes or otherwise destabilizes or dislodges the deposited scale 302, debris and molten material 306 may be ejected from the pipe 300 near the laser head 102. The debris and molten material 306 may be deflected away from the laser head 102 and the high-powered laser beam 124 via the first purging nozzles 106 and second purging nozzles 108. The debris and molten material 306 may be further pulled by the vacuum 114, such that the debris and molten material 306 is taken in and expelled out of the back end 115 of the vacuum 114.

As an area of the pipe 300 is descaled via the high-powered laser beam 124, the magnetic field generators 210 (FIG. 2) may be tuned or the robotic crawlers 200a-b may be activated to move (translated or rotated) along or around the pipe 300 to modify the magnetic field. Modification of the magnetic field may advance or redirect the laser head 102 within the pipe 300 to penetrate and melt further deposited scale 302. The motion of the laser head 102 may be accompanied by flexing of the flexible laser arm 110 in the direction in which the laser head 102 is drawn or repelled by the crawlers 200a-b. In the illustrated embodiment, the flexible laser arm 110 is shown in phantom illustrating a further orientation following movement or tuning of the magnetic field. In the further orientation, the laser head 102 is reoriented, and the laser beam 124 may be emitted at a second target location on the deposited scale 302. The flexing of the flexible laser arm 110 may enable continued provision of the laser energy, purging fluid, and communication through the support arm 118 and into the laser head 102. As illustrated, the support arm 118, and corresponding fiber optic bundle 120 and fluid transport bundle 122 are connected to a control location 308. While the control location 308 is shown as a single location, those skilled in the art will readily appreciate that each sub-component in the control location 308 may be in separate locations without departing from the scope of this disclosure.

The control location 308 may include a laser source 310, such that the high-powered laser beam 124 may be provided through the fiber optic bundle 120 to the laser head 102. In some embodiments, the laser source 310 may be mounted on a truck or trailer, such that large, high-powered laser sources 310 may be provided to the desired control location 308. In some embodiments, the laser source 310 may provide a high-powered laser beam 124 ranging between about 2 kilowatts and about 20 kilowatts. The power of the high-powered laser beam 124 may be tuned based on application, scale type, and severity of scale build-up.

The control location 308 may further include a control unit 312 that may be in communication with the fiber optic bundle 210. The control unit 312 may include a processor 314 and a computer-readable medium 316 which can include instructions for execution by the processor 314. The control unit 312 may further include a wireless communicator 318 which may correspond to and communicate with the wireless communicator 216 on the crawler 200 of FIG. 2. The control unit 312 may receive images from the camera 116 and readings from the sensors 112 via the fiber optic bundle 210, and may further receive information about the robotic crawlers 200a-b via the wireless communicator 318. The control unit 312 may process any received data and may determine an appropriate adjustment for the tool 100 based on the received data. The control unit 312 may then transmit an appropriate instruction or control signal to implement the adjustment to the robotic crawlers 200a-b via the wireless communicator 318. As such, the control unit 312 may finely control motion of the laser head 102 within the pipe 300 without direct manipulation of the laser head 102 within the pipe 300 itself. In some embodiments, the control unit 312 may include a user interface to receive user instructions for adjustment of operations of the robotic crawlers 200a-b. In further embodiments, however, the control unit 312 may autonomously adjust the operations of the robotic crawlers 200a-b based upon instructions stored within the computer-readable medium 316.

The control location 308 may further include a purging fluid source 320, such that the purging fluid may be provided through the fluid transport bundle 122 to the tool 100. In some embodiments, the purging fluid source 320 may be a pressurized fluid tank transportable to the control location 308 as needed. The purging fluid source 320 may be in fluid communication with a pump 322, such that the purging fluid may be provided at high-pressures to the first purging nozzles 106 and the second purging nozzles 108. The pump 322 may accordingly be in fluid communication with the fluid transport bundle 122.

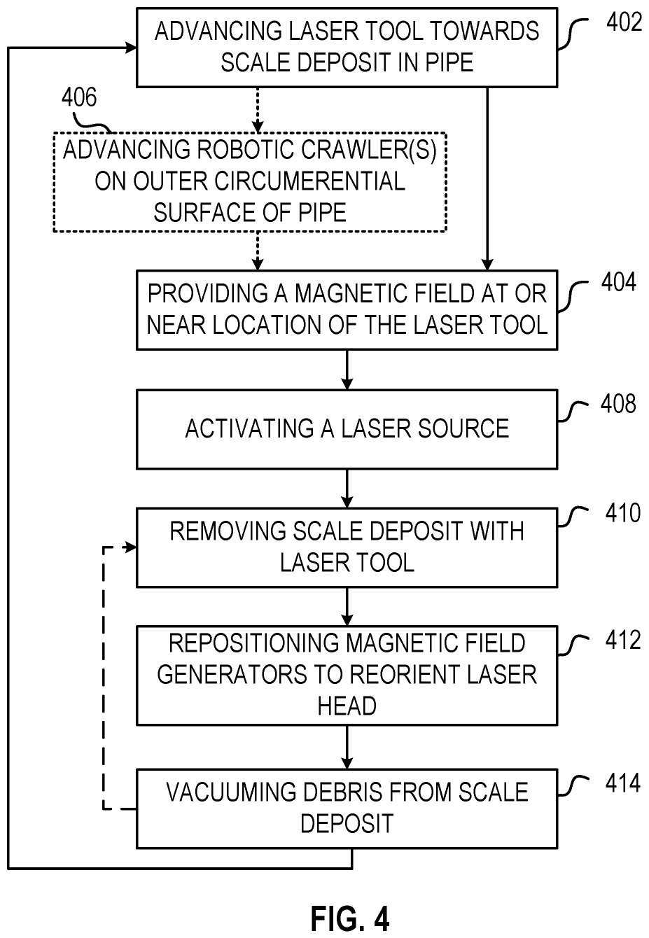

FIG. 4 is a flowchart for an example method 400 for descaling a pipe via a laser descaling tool and robotic crawlers, according to at least one embodiment of the present disclosure. The method 400 may be implemented by the laser descaling tool 100 and robotic crawlers 200a-b on a pipe 300, as shown in FIG. 3. Thus, reference can be made to the example of FIGS. 1-3 in the example of FIG. 4. The method 400 may begin at 402 with advancing a laser descaling tool (e.g., the laser descaling tool 100 of FIGS. 1 and 3) within a pipe (e.g., the pipe 300 of FIG. 3) and towards a scale deposit (e.g., the deposited scale 302 of FIG. 3) within the pipe. A laser descaling tool may be chosen at, or prior to, 402 which includes a vacuum (e.g., the vacuum 114 of FIGS. 1 and 3) that is sized to the inner diameter of the pipe. The laser descaling tool may be run into the pipe on a support arm (e.g., the support arm 118 of FIGS. 1 and 3) to connect the laser descaling tool to a control location (e.g., the control location 308 of FIG. 3). In other embodiments, the laser descaling tool may be pumped, lowered by gravity or otherwise advanced through the pipe. The laser descaling tool may include a laser head (e.g., the laser head 102 of FIGS. 1 and 3) that is formed of iron, an iron alloy, or any other magnetic or ferromagnetic materials compatible with the temperatures and pressures of the descaling application.

The method 400 may continue at 404 with providing a magnetic field at or near the laser tool. In some embodiments, providing a magnetic field may be performed on an outer circumferential surface of the pipe, such that the laser descaling tool is controlled from outside of the pipe. The magnetic field may include a plurality of sources, such that a plurality of permanent magnets, electromagnets or other magnetic field generators may be utilized in affecting motion of the laser head of the descaling laser tool. In at least one embodiment, the method 400 may include advancing one or more robotic crawlers (e.g., the robotic crawlers 200a-b of FIGS. 2-3) along the pipe at 406. The robotic crawlers may be affixed or attached to the outer circumferential surface of the pipe, and may be advanced to the general location of the laser descaling tool at 406. Accordingly, the robotic crawlers advanced at 406 may provide the magnetic field at or near the laser tool at 404. In further embodiments, however, the magnetic field may be provided by a ring-shaped structure of magnets advanced along the pipe, an electromagnetic field generator, or any additional tunable magnetic field generators that may be brought to the location of the laser descaling tool, without departing from the scope of this disclosure.

The method 400 may continue at 408 with activating a laser source (e.g., the laser source 310 of FIG. 3) at a control location. As discussed above, the support arm may connect the laser descaling tool to a control location. The control location may include at a laser source with a fiber optic line running from the laser source to the laser descaling tool via a fiber optic bundle (e.g., the fiber optic bundle 120). In some embodiments, the control location may further include a purging fluid source (e.g., the purging fluid source 320 of FIG. 3) and a control unit (e.g., the control unit 312 of FIG. 3). Activating the laser source at the control location at 408 may produce a high-powered laser beam (e.g., the high-powered laser beam 124 of FIG. 3) from the laser head to begin descaling within the pipe. Accordingly, the method 400 may continue at 410 with removing scale deposits with the laser descaling tool. The high-powered laser beam emitted from the laser head may destabilize or melt the deposited scale within the pipe. Destabilizing or melting the deposited scale may result in chunks of scale to be removed from the overall scale deposit as the laser continues to fire. In some embodiments, the laser descaling tool may include one or more purging nozzle sets (e.g., the first purging nozzles 106 and second purging nozzles 108 of FIGS. 1 and 3). The one or more purging nozzle sets may be in fluid communication with the purging fluid source at the control location, and may expel the purging fluid at or near the laser head. The expelled purging fluid may generate a barrier between the laser head and the scale deposit through which the high-powered laser beam may freely pass, while debris and molten material may be ejected from the area. The one or more purging nozzle sets may be activated at 410 to protect the laser descaling tool in operation.

The method 400 may continue at 412 with repositioning the magnetic field generators to reorient the laser head of the laser descaling tool. The magnetic field, one or more sensors (e.g., the sensors 112 of FIGS. 1 and 3), and/or one or more cameras (e.g., the camera 116 of FIGS. 1 and 3) may be employed in accurate repositioning of the magnetic field generators at 412. As discussed above, the control location may include a control unit, and the control unit may be in communication with the laser descaling tool via the support arm. The control unit may receive signals from the sensors and images from the cameras to determine operating conditions within the pipe. The control unit may be in further (wireless) communication with the source of the magnetic field. In at least one embodiment, the control unit is in wireless communication with a plurality of robotic crawlers. The control unit may use the sensor and camera information to determine the next target at which the laser descaling tool may be aimed. The control unit may then adjust the location or intensity of the source of the magnetic field to adjust the aim of the laser head at 412. In some embodiments, the control unit may signal the plurality of robotic crawlers to move around the pipe, or to alter the intensity of the magnetic field produced by the magnetic field generator (e.g., magnetic field generator 210 of FIGS. 2-3) therein.

The method 400 may continue at 414 with vacuuming of debris from the scale deposit. The vacuuming at 414 may be performed by the vacuum of the laser descaling tool, such that the vacuum may receive any debris and molten material produced at 410. The vacuum may accordingly expel the debris and molten material out towards an entrance of the pipe, such that the debris and molten material are removed from the controlled environment around the laser head. In some embodiments, the vacuum may be connected to a disposal or storage unit for collection and eventual disposal of the removed debris. While the method 400 is depicted as executing in serial, it will be appreciated that at least removing the scale deposit at 410, aiming the laser tool at 412, and vacuuming debris at 414 may be performed in parallel. In some embodiments, removing the scale deposit at 410, aiming the laser tool at 412, and vacuuming debris at 414 may be performed cyclically, such that the method may continue at 410 with removal of further scale deposit.

The method 400 may terminate after complete removal of the scale deposit at 410, aiming of the laser head at 412, and vacuuming away of the scale deposit at 414. In further embodiments, however, the method 400 may continue at 402 with advancing the laser descaling tool within the pipe. In these embodiments, the laser descaling tool may advance towards a further scale deposit, or may advance closer to a deeper section of the same scale deposit. The method 400 may then continue through the pipe until a desired amount of descaling has been performed within the pipe. In this way, the laser descaling tool may enable full descaling of a pipe without damaging chemicals or mechanical abrasives.

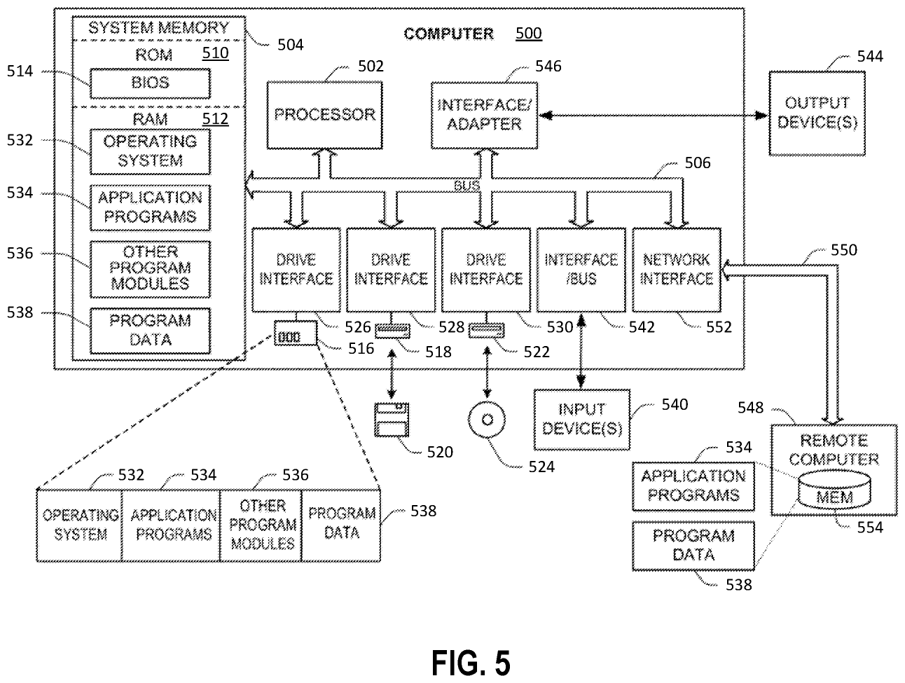

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 5. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 5 illustrates one example of a computer system 500 that can be employed to execute one or more embodiments of the present disclosure. Computer system 500 can be implemented on one or more general purpose networked computer systems, embedded computer systems, routers, switches, server devices, client devices, various intermediate devices/nodes or standalone computer systems. Additionally, computer system 500 can be implemented on various mobile clients such as, for example, a personal digital assistant (PDA), laptop computer, pager, and the like, provided it includes sufficient processing capabilities. In some embodiments, the computer system 500 may be included in the control unit 312, such that the computer system 500 may enable automated or manual control of the laser descaling tool 100 and robotic crawlers 200a-b.

Computer system 500 includes processing unit 502, system memory 504, and system bus 506 that couples various system components, including the system memory 504, to processing unit 502. System memory 504 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 502. System bus 506 may be any of several types of bus structure including a memory bus or memory controller, a peripheral bus, and a local bus using any of a variety of bus architectures. System memory 504 includes read only memory (ROM) 510 and random access memory (RAM) 512. A basic input/output system (BIOS) 514 can reside in ROM 510 containing the basic routines that help to transfer information among elements within computer system 500.

Computer system 500 can include a hard disk drive 516, magnetic disk drive 518, e.g., to read from or write to removable disk 520, and an optical disk drive 522, e.g., for reading CD-ROM disk 524 or to read from or write to other optical media. Hard disk drive 516, magnetic disk drive 518, and optical disk drive 522 are connected to system bus 506 by a hard disk drive interface 526, a magnetic disk drive interface 528, and an optical drive interface 530, respectively. The drives and associated computer-readable media provide nonvolatile storage of data, data structures, and computer-executable instructions for computer system 500. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 510, including operating system 532, one or more application programs 534, other program modules 536, and program data 538. In some examples, the application programs 534 can include sensor processing modules, wireless control modules, image processing software, and magnetic field calculation modules, and the program data 538 can include sensor readings and camera images or videos. The application programs 534 and program data 538 can include functions and methods programmed to receive location and operation data, calculate an ideal magnetic field, and instruct changes to one or more tunable magnetic field sources, such as those shown and described herein.

A user may enter commands and information into computer system 500 through one or more input devices 540, such as a pointing device (e.g., a mouse, touch screen), keyboard, microphone, joystick, game pad, scanner, and the like. For instance, the user can employ input device 540 to edit or modify the power of the magnetic field generators 210, the travel of the robotic crawlers 200a-b, the aim of the camera 116, or any other manual inputs. These and other input devices 540 are often connected to processing unit 502 through a corresponding port interface 542 that is coupled to the system bus, but may be connected by other interfaces, such as a parallel port, serial port, or universal serial bus (USB). One or more output devices 544 (e.g., display, a monitor, printer, projector, or other type of displaying device) is also connected to system bus 506 via interface 546, such as a video adapter.

Computer system 500 may operate in a networked environment using logical connections to one or more remote computers, such as remote computer 548. Remote computer 548 may be a workstation, computer system, router, peer device, or other common network node, and typically includes many or all the elements described relative to computer system 500. The logical connections, schematically indicated at 550, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 500 can be connected to the local network through a network interface or adapter 552. When used in a WAN networking environment, computer system 500 can include a modem, or can be connected to a communications server on the LAN. The modem, which may be internal or external, can be connected to system bus 506 via an appropriate port interface. In a networked environment, application programs 534 or program data 538 depicted relative to computer system 500, or portions thereof, may be stored in a remote memory storage device 554.

Embodiments disclosed herein include:

A. A pipe descaling system, comprising a pipe having a scale deposit on an inner circumferential surface thereof, one or more crawlers selectively movable on an outer circumferential surface of the pipe, one or more magnetic field generators carried by the one or more crawlers and operable to produce a magnetic field, and a laser descaling tool operable to emit a laser beam, the laser descaling tool including a support arm extending into the interior of the pipe, a flexible laser arm having a first end coupled to an end of the support arm within the interior of the pipe, and a laser head coupled to a second end of the flexible arm and defining an opening through which the laser beam is emitted, the laser head formed of a magnetic or ferromagnetic material such that the laser head is attracted or repelled by the magnetic field and such that movement of the magnetic field generators with the crawlers on the outer circumferential surface of the pipe flexes the flexible arm to reorient the laser head.

B. A method for descaling a pipe, the method comprising advancing a laser descaling tool into the pipe towards a scale deposit, the laser descaling tool including a laser head formed of magnetic or ferromagnetic materials, positioning a magnetic field generator on an outer circumferential surface of the pipe, generating, via the magnetic field generator, a magnetic field at or near a location of the laser descaling tool, activating a laser source optically coupled to the laser head to thereby emit a laser beam from the laser head at a first target location on the scale deposit, removing scale from the first target location with the laser beam, and modifying the magnetic field by tuning or repositioning the magnetic field generator on the outer circumferential surface of the pipe to thereby attract or repel the laser head with the magnetic field and reorient the laser head such that the laser beam is emitted at a second target location on the scale deposit.

C. A laser descaling tool comprising a laser head formed of a magnetic or ferromagnetic material, a flexible laser arm defining first and second ends, the flexible laser arm coupled to the laser head at the first end and responsive to modification of a magnetic field to reorient the laser head, a support arm coupled to the flexible laser arm at the second end, a fiber optic cable extending through the flexible laser arm and the support arm to a control location, a laser source disposed at the control location and optically coupled to the laser head through the fiber optic cable, and a vacuum mounted at the second end of the laser arm and operable to collect debris from a scale deposit within an interior of a pipe.

Each of embodiments A through C may have one or more of the following additional elements in any combination: Element 1: wherein the one or more crawlers include: a body; at least one motor housed within the body; and a plurality of wheels mounted on the body and operably coupled to the at least one motor. Element 2: wherein the plurality of wheels are magnetically coupled to the outer circumferential surface of the pipe. Element 3: wherein the robotic crawlers further include: one or more tracks attached to two or more of the plurality of wheels, wherein the tracks are magnetically coupled to the outer circumferential surface of the pipe. Element 4: wherein the one or more crawlers further include: a processor communicatively coupled to the magnetic field generator; a computer-readable medium communicatively coupled to the processor and storing instructions for operation of the robotic crawlers and magnetic field generators; and a wireless communicator operable to send and receive signals and communicatively coupled to the processor and computer-readable medium. Element 5: wherein the laser descaling tool further includes: a vacuum mounted at or near the flexible laser arm, the vacuum operable to collect debris from at or near the laser head. Element 6: further comprising: a fiber optic cable extending through at least one of the flexible laser arm and the support arm; and laser source optically coupled to the fiber optic cable, wherein the laser source is operable to provide the laser beam to the laser head via the fiber optic cable.

Element 7: wherein the laser descaling tool further includes: one or more sets of purging nozzles at or near the laser head; and one or more fluid transport lines in fluid communication with the purging nozzles and included within the flexible laser arm and support arm. Element 8: further comprising: a purging fluid source mated to the transport lines; and a pump interposing the purging fluid source and the purging nozzles and operable to provide purging fluid at a specified pressure to the purging nozzles. Element 9: wherein the laser descaling tool further includes: one or more pressure transducers, one or more temperature sensors, one or more cameras, or any combination thereof. Element 10: further comprising: a control unit in communication with the one or more crawlers, and the pressure transducers, temperature sensors, cameras, or any combination thereof, the control unit including: a processor; and a computer-readable medium storing instructions which, when executed by the processor, adjust operations of the robotic crawlers and aim the high-powered laser beam toward the scale deposit. Element 11: further comprising: advancing the magnetic field generator along the outer circumferential surface of the pipe with one or more robotic crawlers carrying the magnetic field generator. Element 12: further comprising: collecting debris and/or molten material dislodged from the scale deposit via a vacuum mounted on the laser descaling tool.

Element 13: wherein modifying the magnetic field includes: receiving a signal from one or more sensors of the laser descaling tool; and translating the magnetic field generator and/or tuning the magnetic field generator in response to the signal from the one or more sensors. Element 14: further comprising: receiving an image and/or video from a camera mounted on the laser descaling tool; and repositioning the magnetic field generators in response to the received image and/or video. Element 15: further comprising: one or more pressure transducers, one or more temperature sensors, one or more cameras, or any combination thereof. Element 16: further comprising: one or more sets of purging nozzles mounted at or near the laser head and fluidly coupled to a purging fluid source. Element 17: wherein the flexible laser arm and the support arm further include a fluid transport bundle in fluid communication with the one or more sets of purging nozzles and the purging fluid source.

By way of non-limiting example, exemplary combinations applicable to A through C include: Element 1 with Element 2; Element 1 with Element 3; Element 7 with Element 8; Element 9 with Element 10; Element 13 with Element 14; and Element 16 with Element 17.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A pipe descaling system, comprising:
a pipe having a scale deposit on an inner circumferential surface thereof;
one or more crawlers selectively movable on an outer circumferential surface of the pipe;
one or more magnetic field generators carried by the one or more crawlers and operable to produce a magnetic field; and
a laser descaling tool operable to emit a laser beam, the laser descaling tool including:
a support arm extending into the interior of the pipe;
a flexible laser arm having a first end coupled to an end of the support arm within the interior of the pipe; and
a laser head coupled to a second end of the flexible arm and defining an opening through which the laser beam is emitted, the laser head formed of a magnetic or ferromagnetic material such that the laser head is attracted or repelled by the magnetic field and such that movement of the magnetic field generators with the crawlers on the outer circumferential surface of the pipe flexes the flexible arm to reorient the laser head.

2. The system of claim 1, wherein the one or more crawlers include:
a body;
at least one motor housed within the body; and
a plurality of wheels mounted on the body and operably coupled to the at least one motor.

3. The system of claim 2, wherein the plurality of wheels are magnetically coupled to the outer circumferential surface of the pipe.

4. The system of claim 2, wherein the robotic crawlers further include:
one or more tracks attached to two or more of the plurality of wheels, wherein the tracks are magnetically coupled to the outer circumferential surface of the pipe.

5. The system of claim 1, wherein the one or more crawlers further include:
a processor communicatively coupled to the magnetic field generator;
a computer-readable medium communicatively coupled to the processor and storing instructions for operation of the robotic crawlers and magnetic field generators; and
a wireless communicator operable to send and receive signals and communicatively coupled to the processor and computer-readable medium.

6. The system of claim 1, wherein the laser descaling tool further includes:
a vacuum mounted at or near the flexible laser arm, the vacuum operable to collect debris from at or near the laser head.

7. The system of claim 1, further comprising:
a fiber optic cable extending through at least one of the flexible laser arm and the support arm; and
laser source optically coupled to the fiber optic cable, wherein the laser source is operable to provide the laser beam to the laser head via the fiber optic cable.

8. The system of claim 1, wherein the laser descaling tool further includes:
one or more sets of purging nozzles at or near the laser head; and
one or more fluid transport lines in fluid communication with the purging nozzles and included within the flexible laser arm and support arm.

9. The system of claim 8, further comprising:
a purging fluid source mated to the transport lines; and
a pump interposing the purging fluid source and the purging nozzles and operable to provide purging fluid at a specified pressure to the purging nozzles.

10. The system of claim 1, wherein the laser descaling tool further includes:
one or more pressure transducers, one or more temperature sensors, one or more cameras, or any combination thereof.

11. The system of claim 10, further comprising:
a control unit in communication with the one or more crawlers, and the pressure transducers, temperature sensors, cameras, or any combination thereof, the control unit including:
a processor; and
a computer-readable medium storing instructions which, when executed by the processor, adjust operations of the robotic crawlers and aim the high-powered laser beam toward the scale deposit.

12. A method for descaling a pipe, the method comprising:
advancing a laser descaling tool into the pipe towards a scale deposit, the laser descaling tool including a laser head formed of magnetic or ferromagnetic materials;
positioning a magnetic field generator on an outer circumferential surface of the pipe;
generating, via the magnetic field generator, a magnetic field at or near a location of the laser descaling tool;
activating a laser source optically coupled to the laser head to thereby emit a laser beam from the laser head at a first target location on the scale deposit;
removing scale from the first target location with the laser beam; and
modifying the magnetic field by tuning or repositioning the magnetic field generator on the outer circumferential surface of the pipe to thereby attract or repel the laser head with the magnetic field and reorient the laser head such that the laser beam is emitted at a second target location on the scale deposit.

13. The method of claim 12, further comprising:
advancing the magnetic field generator along the outer circumferential surface of the pipe with one or more robotic crawlers carrying the magnetic field generator.

14. The method of claim 12, further comprising:
collecting debris and/or molten material dislodged from the scale deposit via a vacuum mounted on the laser descaling tool.

15. The method of claim 12, wherein modifying the magnetic field includes:
receiving a signal from one or more sensors of the laser descaling tool; and
translating the magnetic field generator and/or tuning the magnetic field generator in response to the signal from the one or more sensors.

16. The method of claim 15, further comprising:
receiving an image and/or video from a camera mounted on the laser descaling tool; and
repositioning the magnetic field generators in response to the received image and/or video.

17. A laser descaling tool comprising:
a laser head formed of a magnetic or ferromagnetic material;
a flexible laser arm defining first and second ends, the flexible laser arm coupled to the laser head at the first end and responsive to modification of a magnetic field to reorient the laser head;
a support arm coupled to the flexible laser arm at the second end;
a fiber optic cable extending through the flexible laser arm and the support arm to a control location;
a laser source disposed at the control location and optically coupled to the laser head through the fiber optic cable; and
a vacuum mounted at the second end of the laser arm and operable to collect debris from a scale deposit within an interior of a pipe.

18. The laser descaling tool of claim 17, further comprising:
one or more pressure transducers, one or more temperature sensors, one or more cameras, or any combination thereof.

19. The laser descaling tool of claim 17, further comprising:
one or more sets of purging nozzles mounted at or near the laser head and fluidly coupled to a purging fluid source.

20. The laser descaling tool of claim 19, wherein the flexible laser arm and the support arm further include a fluid transport bundle in fluid communication with the one or more sets of purging nozzles and the purging fluid source.
